(19) United States
(12) Patent Application Publication
(10) Pub. No.: US 2016/0275219 A1
(43) Pub. Date: Sep. 22, 2016

(54) SIMULATING AN INDUSTRIAL SYSTEM

(71) Applicant: Siemens Product Lifecycle Management Software Inc., Plano, TX (US)

(72) Inventors: Zvi Feuer, Yehud (IL); Vladimir Medvedev, Moscow (RU); Noam Ribon, Ann Arbor, MI (US); Erica Claire Simmons, Dallas, TX (US); Victor Michael Vainshtain, Herzliya (IL)

(21) Appl. No.: 14/664,467

(22) Filed: Mar. 20, 2015

(51) Int. Cl. G06F 17/50; G06F 17/18

(52) U.S. Cl. CPC G06F 17/5009; G06F 17/18

(57) ABSTRACT

System and method for simulating an industrial system with a plurality of industrial processes in communication with each other directly or indirectly. The systems and method include: simulating a plurality of industrial processes by providing a set of simulation components, wherein each simulation component simulates one or more industrial processes; defining, for each simulation component, a corresponding encapsulating simulation component; and simulating the industrial system.

### TECHNICAL FIELD

The present disclosure is directed, in general, to computer-aided design (“CAD”), visualization, engineering (“CAE”) and manufacturing (“CAM”) systems, product lifecycle management (“PLM”) systems, and similar systems, that manage data for products and other items (collectively, “Product Data Management” systems or PDM systems).

The present disclosure is directed to methods and apparatuses for simulating industrial systems, in particular, complex industrial system which are hierarchical and multilayer.

### BACKGROUND OF THE DISCLOSURE

Industrial systems in the field of manufacturing, power and chemical plants, infrastructure projects, traffic management systems and similar have often a very complex architecture consisting of several different industrial processes which are in communication with each other in a hierarchical multilayer architecture. An industrial process can be seen as a set of intermediate steps needed to create an item or a product, usually repeated to create multiple units of the same item, where generally it might be involved the use of raw materials, machinery and/or manpower. Examples of industrial processes include one or more of manufacturing lines, warehouse management, logistics delivery, infrastructure maintenance and others.

The task of simulating the wide aspects of such complex industrial systems is essential for improving and optimizing production, reducing risks and costs. Examples of industrial systems to be simulated may include, but is not limited to, the maintenance planning and the dismantling of nuclear power plants, the handling of radioactive or other aggressive waste, ecological and environment impacts of production phases, traffic management and others.

Improved systems are desirable.

### SUMMARY OF THE DISCLOSURE

Various disclosed embodiments include methods and systems for simulating an industrial system with a plurality of industrial processes in communication with each other directly or indirectly. The systems and method include: simulating said plurality of industrial processes by providing a set of simulation components, wherein each simulation component simulates one or more industrial processes; defining, for each simulation component, a corresponding encapsulating simulation component which is transforming the output data, received by its corresponding simulation component in a proprietary format, into output communication data in a standardized format, in order to send the output communication data to any other encapsulating simulation component and/or to an external module. If said encapsulating simulation component receives input communication data in a standardized format from any other encapsulating component and/or from an external module, it transforms the input communication data into input data in a proprietary format specific to its corresponding simulation component, in order to receive the input communication data from any other encapsulating simulation component and/or from an external module. The industrial system is simulated by putting in communication at least two encapsulating simulation components with each other which communicate via communication data in a standardized format, so as to mirror the communication of the industrial processes simulated by the corresponding simulation components.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure and the advantages thereof, reference is now made to the following descriptions taken in conjunction with the accompanying drawings, wherein like reference signs designate like objects, and in which:

FIG. 1 is a block diagram schematically illustrating an example embodiment of encapsulating simulation components in communication within a simulation system;

FIG. 2 is a block diagram schematically illustrating an example embodiment of a structure of a standard communication interface, for providing input/output communication data with a standardized format;

FIG. 3 is a block diagram schematically illustrating an exemplary simulation system in a multilevel hierarchical architecture according to an embodiment;

FIG. 4 is a block diagram schematically illustrating an exemplary simulation system SIM in a “master and slave” architecture, according to an embodiment;

FIG. 5 is a block diagram schematically illustrating an example embodiment of an encapsulating simulation component wherein the corresponding simulation component is an active real sample cell;

FIG. 6 is a block diagram schematically illustrating an example embodiment of an encapsulating simulation component wherein the corresponding simulation component is a virtual sample cell;

FIG. 7 illustrates a block diagram of a data processing system in which an embodiment can be implemented;

FIG. 8 illustrates a flowchart of a method for simulating an industrial system comprising a plurality of communicating industrial processes in accordance with disclosed embodiments.

### DETAILED DESCRIPTION

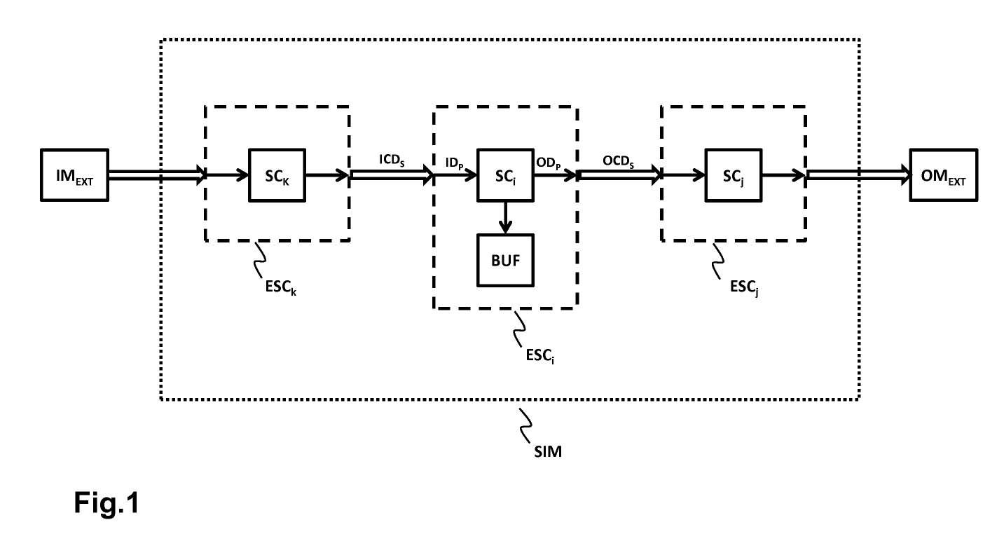

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged method or system. The numerous innovative teachings of the present application will be described with reference to exemplary non-limiting embodiments.

It is a conventional practice to utilize simulation components to simulate one or more of the industrial processes constituting the industrial system. Examples of simulation components include one simulation engines or packages, stochastic event based simulation engines, non-stochastic simulation engines, real and virtual sample cells, data source units with, for example, measured data from real objects and other components. Thus simulation components may be software, hardware, real objects and any combination thereof. When a producing plant or industrial system has a complex hierarchical multilayer architecture in which a large variety of processes are in communication with each other, it is usually not realistic to find one single simulation component able to simulate such large variety of industrial processes which might be intrinsically different from each other and thus not compatible with each other. Examples of industrial processes which are not compatible but still part of the same technological car manufacturing chain may be: the industrial process of the line producing small parts, the industrial process of the assembly line having longer time cycles and fundamentally different equipment pieces and the industrial process of the painting department.

In the field, in order to attempt to simulate a complex industrial system, different types of simulation components are used to simulate the various industrial process types involved. For example one can use simulation engines such as Siemens Plant Simulation, Siemens Process Simulation and other Siemens manufacturing oriented products (collectively available from Siemens Product Lifecycle Management Inc., Plano, Tex.), or other simulation engines and computational modeling engines to simulate parts of complex producing systems. Hence, a large variety of different and often not compatible simulation components might often to be used.

The problem is that many of such simulation components may usually be not compatible with each other so that the simulation system comprising them results to be non-homogenous. Simulation components are not compatible with each other when they cannot operate satisfactorily in a cooperative manner within the same simulation systems. One or more industrial processes are considered to be compatible with each other when they are interchangeable with each other without significant changes. For example, one or more industrial processes are not compatible with each other when they have different time scales, they have different measuring scales, when their input-output communication data require interpretation, and/or when their objects have different structures and properties, e.g. different items, different pieces of equipment, different functionalities and for other reasons. Simulation components which are designed to simulate some specific industrial processes that are not compatible with each other result also to be non-compatible with each other, e.g the corresponding simulating components may have the same incompatibility factors, such as different times scales, incompatible input/output data terminology and different structures and proprieties and so on. However, simulation components simulating the same industrial processes may also be incompatible for a large variety of other reasons. For example, two simulation components may have two different simulation engines from different vendors. For example, two simulation components may simulate compatible industrial processes from a totally different perspective with other parameters and properties (e.g. one simulation engine analyzes cost factors and the other simulation engine simulates environmental impacts). Thus, it is often the case that at least a few simulation components aimed at simulating industrial processes of a given complex industrial system will be incompatible with each other since it may often be the case such simulation components do not analyze the same physical laws, they have different logical rules, they are controllable by different tools, they have different time and measuring scale and/or other sources of incompatibilities.

Some examples simulation techniques are listed below, the disclosures of which are incorporated herein by reference to the extent permitted by law:
“Systems and Methods for Immersive Interaction with Actual and/or Simulated Facilities for Process, Environmental and Industrial Control,” U.S. Pat. No. 8,594,814;
“Dynamic Simulation of a System of Interdependent Systems,” U.S. Pat. No. 8,589,133;
“Traffic Data Management and Simulation System,” U.S. Pat. No. 8,484,002;
“Simulation Apparatus and Method Used for Sensor Network,” U.S. Pat. No. 8,364,457;
“Method for Displaying Traffic Information and Navigation System,” U.S. Pat. No. 8,296,062;
“Apparatus and Method for Simulating Multi-Dimensional Non-Linear Multivariable Processes,” U.S. Pat. No. 8,195,581;
“Context-Based Synthesis of Simulation Models from Functional Models of Cyber-Physical Systems,” U.S. Patent App'l Pub. No. US20140019104;
“Distributed Simulation System for Jet Engine Based on Grid,” China Patent Publication No. CN1731405A, App'l No.: CN 200510027719, Filing date Jul. 14, 2005, also published as CN100337238C.

There is a need of overcoming the drawbacks of present systems by providing a method of simulating an industrial system in which a wide variety of different simulation component types are able to work together in a flexible and modular manner, even when two or more of such components are incompatible with each other. Some of the drawbacks of currents simulation systems and techniques include, but are not limited to:
Techniques are closed and oriented to a specific producing facility. Hence, when different simulation models of some other producing processes are required, the whole entire system model needs to be re-designed from scratch.
When it is required to change some characteristics of a given simulation component, e.g. the parameters of the included simulation engine, it is then necessary to change several properties of the other simulation components depending from the given simulation component, and, unfortunately, to reprogram the whole environment.
Techniques do not allow creating a full system simulation when some simulating components do not meet the compatibility requirements.
Techniques do not allow performing the work simultaneously in the different time scales.
Techniques do not allow creating a unified simulation system for industrial processes which are incompatible.
Techniques do not allow using incompatible simulation engines in the same simulation system.
Techniques do not allow simultaneously using several identical simulations engines for fundamentally different processes in the same simulation system.
Techniques do not allow performing “pure” sub-simulation, so, their simulation systems include a control functions with internal feedback connections, which do not enable a modular structure in form of a collection of independent “pure” sub-processes.
Techniques do not allow performing cascade and/or variants simulation.
Techniques suffer from loss of the modularity and the ability to reuse components.
Techniques do not allow executing pre-recorded components behavior.
Techniques are lacking a mechanism for reporting and data analysis.
Techniques suffer of a loss of flexibility in several aspects.

FIG. 1 is a block diagram schematically illustrating an example embodiment of encapsulating simulation components in communication within a simulation system. At least some embodiments address the above described issue in which a method and or corresponding systems is simulating an industrial system comprising at least two industrial processes in communication with each other directly or indirectly. The industrial processes are simulated via a set of simulation components SCᵢ, SCⱼ, SC_{K}. Each simulation component SCᵢ may comprise one or more of the following sub-components such as, for example, a simulation engine, a data source unit, a real sample cell, or any combination thereof if compatible with each other. Each simulation component SCᵢ, SCⱼ, SCₖ can simulate one industrial processes or a group of industrial processes if they are compatible with each other. In a preferred embodiment, at least two simulation components SCᵢ, SCⱼ in the simulation system SIM are not compatible with each other, for example they have a different time scale. Assume, for example, an industrial process comprising five different industrial processes. A group of three compatible industrial processes are simulated by a first simulation component SCᵢ which might for example be a stochastic based simulation engine, while the other two processes are simulated by a second simulation component SCⱼ, and by third simulation component SCₖ, respectively. The second simulation component SCⱼ might, for example, be a data source unit, while the third simulation component might be a combination of a real sample cell and another simulation engine. For each simulation component SCᵢ, SCⱼ, SCₖ it is defined a corresponding encapsulating simulation component ESCᵢ. As used herein, the term “encapsulating” is not to be intended as a “hard-defined” encapsulation but as a “customizable” encapsulation providing abstraction functionalities in achieving multi-aspect flexible data transformations as it will be apparent from the disclosure. The term “abstract” and the derivatives thereof are used in the non-limiting context of flexible data transformations and not in the sense of an amorphous idea. The encapsulating simulation component ESCᵢ is transforming the output data OD_{P}, received by its corresponding simulation component SCᵢ in a proprietary format, into output communication data OCD_{S} in a standardized format, in order to send the output communication data OCD_{S} to any other encapsulating simulation component ESCⱼ and/or to an external module (not shown, in fact the output external module OM_{EXT} shown in FIG. 1 receives output communication data in a standardized format from another encapsulating simulation component ESCⱼ). If the encapsulating simulation component ESCᵢ receives input communication data ICD_{S} in a standardized format from any other encapsulating component ESCₖ and/or from an external module (not shown, in fact the input external module IM_{EXT} shown in FIG. 1 sends input communication data in a standardized format to another encapsulating simulation component ESCₖ), the encapsulating simulation component ESCᵢ is transforming it into input data ID_{P} in a proprietary format specific to its corresponding simulation component SCᵢ, in order to receive the input communication data ICD_{S} from any other encapsulating simulation component ESC_{K} and/or from an external module.

The external modules are modules external to the simulation system SIM and allow exchanging information, locally or remotely through a communication network, with the external environment, optionally comprising external users. Embodiment examples of external module OM_{EXT},IM_{EXT} may be: user interface module, data module, library, controller, computer, software application, data processing system and any combination thereof. Those skilled in the art will appreciate that they may readily use other implementations of external modules for carrying out the same purposes of the present disclosure. In FIG. 1, it is shown two exemplary types of external modules OM_{EXT}, IM_{EXT}: the first external module being an output external module OM_{EXT}—receiving output communication data from the last encapsulating simulation component in the cascade ESCⱼ. This output external module OM_{EXT} might, for example, be a data processing system; the second external module being an input external module IM_{EXT} sending input communication data to the first encapsulating simulation component in the cascade ESCⱼ. This input external module IM_{EXT} might, for example, be a controller. Examples of external software applications with which the simulation system SIM may exchange information may conveniently be a navigation system, an applied system such as ALARA (As Low As Reasonable Achievable), an infrastructure supervision system and others. In one embodiment, the user interface can connect to an expert user in order to program the behavior of one or more encapsulating simulation components. Advantageously, the language used by the user can be a natural language while the data exchanged with the encapsulating simulation component is in a standardized format. In one embodiment, the user interface can be connected to a Q&A professional who analyzes the simulation results for reporting purposes. A data module may advantageously be used to receive and/or send data from/to encapsulating simulation components to/from the external world, as for example, in an embodiment, with an external impact module. A data processing system is a combination of machines, as for example processors and repositories, and eventually people that for a set of inputs produces a defined set of outputs, for example for performing statistical analysis of received data, for reporting purposes and similar. The skilled in the art easily appreciated that, in other embodiments, an external module may conveniently be enabled to communicate with encapsulating simulating components in both directions, as for example it is the case with a computer or with a controller.

In one embodiment, one or more simulation components SCᵢ may be conveniently connected to a local state buffer BUF. Advantageously, such simulation component SCᵢ connected to the buffer BUF may be temporarily used for other purposes, e.g. for stability region clarifications, while the simulation component state data are stored in the buffer BUF, so that it is possible to return to the interrupted functionalities. Advantageously, through the buffer “undo” and “re-do” functionalities may be allowed.

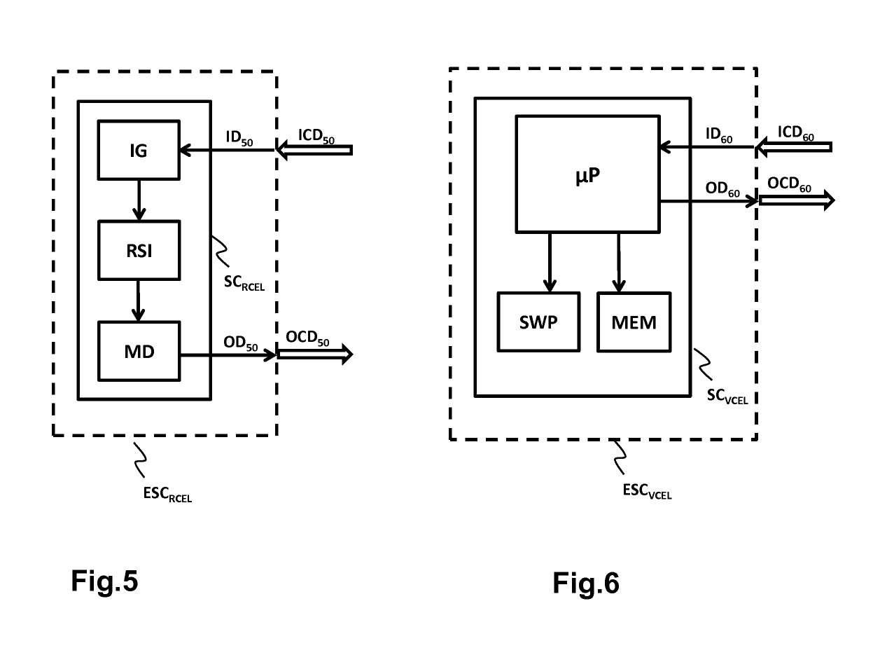

The encapsulating simulation components ESCᵢ, ESCⱼ, ESCₖ do act as modular encapsulating components so that the connections to any other encapsulating simulation components or external modules are “isolated” through an interface capable of encapsulating their output data and transform it into a standardized format. Advantageously, each encapsulating simulation component ESCᵢ, ESCⱼ, ESCₖ is content independent and it may comprise simulation at least two components SCᵢ, SCⱼ, SCₖ which are incompatible with each other. Examples of simulation component types may include: simulation engines, stochastic based simulation engines, data source units, real sample cells, virtual sample cells, any combination of the previous components if compatible. Hence, a simulation component SCᵢ may be constituted by a real sample cell (see example embodiment of FIG. 5) to a set of compatible stochastic simulation engines (not shown). A simulation engine may advantageously be a stochastic simulation engine or a non-stochastic simulation engine. Data source units provide modeling data originated either from a simulation engine or pre-recorded sampled data or from other sources. Data source units may be seen as degenerated simulators. In one embodiment, at least one simulation component in the simulation system comprises a stochastic based simulation engine.

In other embodiments, each encapsulating simulation component ESCᵢ, ESCⱼ, ESCₖ may conveniently have any position in the multilevel hierarchical architecture of the whole simulation system SIM, being the input and output communication data in a standardized format, allowing a standard connection to any other encapsulating simulation component present in the whole simulation system SYM. In embodiments, each encapsulating simulation component ESCᵢ, ESCⱼ, ESCₖ may conveniently be provided with a unique marker, e.g. an ID number or another identifier type, in order to define the given instance of each simulation component ESCᵢ, ESCⱼ, ESCₖ in the simulation system SIM.

Embodiments facilitate the optimization of industrial systems by enabling flexible system simulations through a convenient multilevel hierarchical architecture in which at least two incompatible simulation components are combined and aligned together so as to be orchestrated to work in unified a simulation system mirroring the architecture of the processes within the industrial system.

Embodiments enable the presence of several distinguished simulator packages and/or computational engines, using different computational models, which work in a collaborative manner to provide a targeted unified system simulation, which may conveniently be stochastic based.

Embodiments support an independent time scale and/or an independent measuring scale for different encapsulating simulation components in the simulation system.

Embodiments allow a simulation component to be isolated through the encapsulation provided by its corresponding encapsulating simulation component.

Embodiments provide an interface concept so that the encapsulating simulation components are modular and may be enabled to work independently in the simulation system.

Embodiments enable each encapsulating simulation component in the simulation system to be functionally complete, so that it may be conveniently be enabled to work, in its own domain of existence, offline, without the need of changing something in its structure beside, upon need, in the part which is performing data transformation between standard format and proprietary format. Embodiments allow easy reusability of a simulation component thanks to the encapsulation provided by its corresponding encapsulating simulation component. Embodiments allow easy replacement of obsolete simulation components with new ones and easy upgrades. Embodiments allow a modular, distributed and open architecture for the simulation system simulating a complex industrial system. Embodiments enable that the simulation system be partitioned in chunks—comprising one or more encapsulating simulation components—so that such chunks can be advantageously executed in asynchronous manner. Each partial chunk of the simulation system can be executed independently upon a request, without the need to execute the others. Hence, the simulation system can combine partial chunk result to provide results for the complete system simulation. The chunk results may be real recordings, hardware emulation measurements, up-front generated simulation results for optimizations which are computationally intensive. Embodiments enable to invoke the execution of the encapsulating simulation components in a separate manner in order to search some optimal parameters or a stability region for the associated simulation component. Advantageously, through separate invocation, it is not required to re-run the full hierarchical system simulation in order to get the results of the full system simulation.

Embodiments allow designing a simulation system in the stochastic event simulation domain comprising at least a stochastic based simulation engine and one or more different simulation components. Embodiments enable extending the applicability of the concepts typical of the stochastic event simulation field to a greater variety of industrial scenarios and types.

Embodiments enable to increase the accuracy of the model behavior to the reality through a real recorded data feed possibility. Embodiments allow to significantly extend the scope of the simulation by combining incompatible simulation components and to improve the simulation accuracy with minimal efforts. Embodiments enable to reduce software development costs and to increase reusability.

Embodiments prove particularly useful in fields where large and complex industrial systems have to be simulated, since it is provided a technique for dividing a complex model into smaller encapsulating simulating components that are communicating with each other in a standardized format without any information loss.

Embodiments enable enabling the communication with users in their natural language via interactive guide systems. Embodiments enable saving state data of a simulation component into a local state buffer so that the simulation component execution may advantageously be interrupted and easily restored. Numerous other benefits exist.

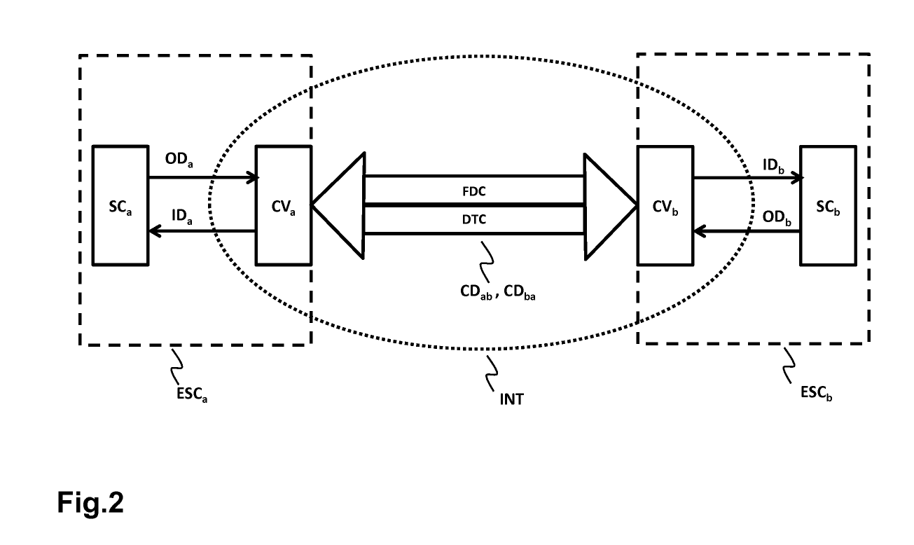

FIG. 2 is a block diagram schematically illustrating an example embodiment of a structure of a standard communication interface, for providing input/output communication data with a standardized format. The standard communication interface INT shown in FIG. 2 can be seen as a shared boundary across which the two different encapsulating simulation components ESCₐ, ESC_{b} are exchanging communication data CD_{ab} in a standardized format. The communication exchange can be between software, hardware, peripheral devices and any combinations of these. The shown standard communication interface INT comprises two data channels, a format data channel FDC and a data transfer channel DTC, for conveying the communication data CD_{ab}, CD_{ba} in a standardized abstract data format and two data converters CVₐ, CV_{b} for transforming the data from standardized format data CD_{ab}, CD_{ba} to proprietary format data IDₐ, ID_{b} and for transforming the data from proprietary format data ODₐ, OD_{b} to standardized format data CD_{ab}, CD_{ba}. The first data converter CVₐ is located inside the first encapsulating simulation component ESCₐ and the second data converter is located inside the second encapsulating simulation component ESC_{b}. The data channel DTC is a data transfer channel comprising converted abstract data in a standard format to provide information compatibility in the system on the program level. The data channel FDC is a format definition channel and it defines the coding and the coding to be done in the abstract data format which is present on the data transfer channel DTC. The data converters CVₐ, CV_{b} transform the data in the proprietary format of the simulation component SCₐ, SC_{b} in the standardized format data in accordance with the format definition channel FDC and vice versa, without any information loss. The data converters CVₐ, CV_{b} can be interpreted as the abstracting data transfer channel DTC instance creators. In an example embodiment, the interface INT may be realized as sequence of information blocks in the memory, comprising the format definition channel FDC and the data transfer channel DTC converted by the corresponding data converters CVₐ, CV_{b}. Those skilled in the art will easy recognize that the data in standardized format may be realized differently from the described embodiment. Moreover, those skilled in the art will easy recognize and the data converters CVₐ, CV_{b} perform different transformations depending with the types of source/target data in proprietary formats. In some cases, no data transformation might be required, i.e. when the proprietary format is the same than the standardized format.

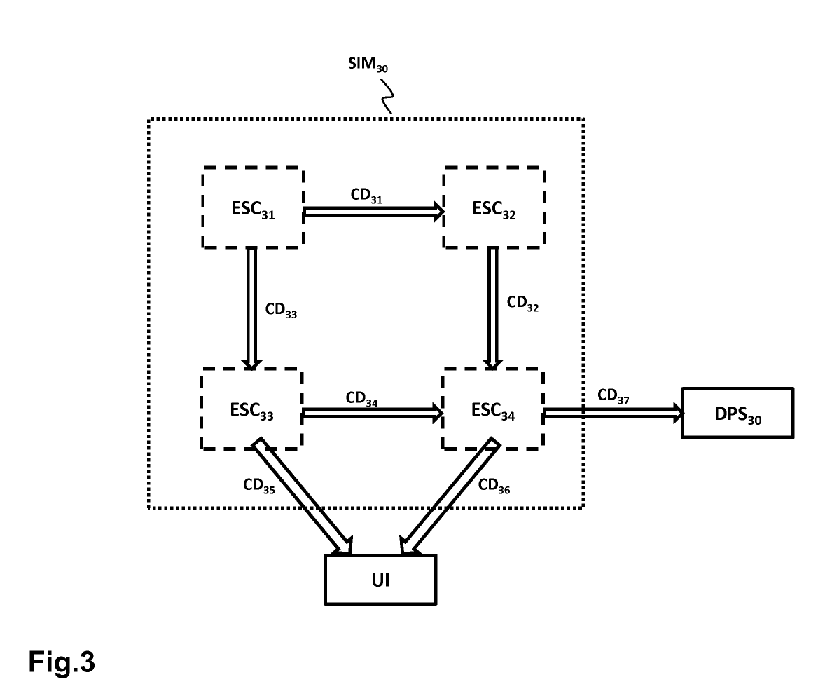

FIG. 3 is a block diagram schematically illustrating an exemplary simulation system SIM₃₀ in a multilevel hierarchical architecture according to an embodiment. Assume, for example, that it is required to simulate a given multilevel hierarchical production system, consisting of four incompatible processes communicating with each other in a 2×2 architecture. Each encapsulating simulation component ESC₃₁, ESC₃₂, ESC₃₃, ESC₃₄ is encapsulating a simulation component (not shown) or a group of simulation components (not shown) simulating one process or a group of compatible processes. For example, ESC₃₁ may comprise a simulation engine (not shown) and two real compatible sample cells (not shown), all communicating with each other in a proprietary data format. The four encapsulating simulation components ESC₃₁, ESC₃₂, ESC₃₃, ESC₃₄ are in a 2×2 matrix configuration communicating with each other with input/output communication data CD₃₁, CD₃₃, CD₃₃, CD₃₄ in a standardized format. It is shown an external module in form of user interface UI, for example connected to an expert user (not shown) or a Quality & Assurance professional (not shown), common to the two lower encapsulating simulation components ESC₃₃, ESC₃₄ and it is communicating with communication data D₃₅, D₃₆ in a standardized format. In other embodiments, each encapsulating simulation component ESC₃₁, ESC₃₂, ESC₃₃, ESC₃₄ may advantageously be in communication with its own corresponding user interface module. It is shown another external module in form of data processing system DPS₃₀ receiving communication data CD₃₇ in a standardized format. Those skilled in the art will appreciate that embodiments enable the flexible creation of large variety of topologies of encapsulating simulation component networks in various dimensions and shapes, as for example matrix, spatial matrix and others.

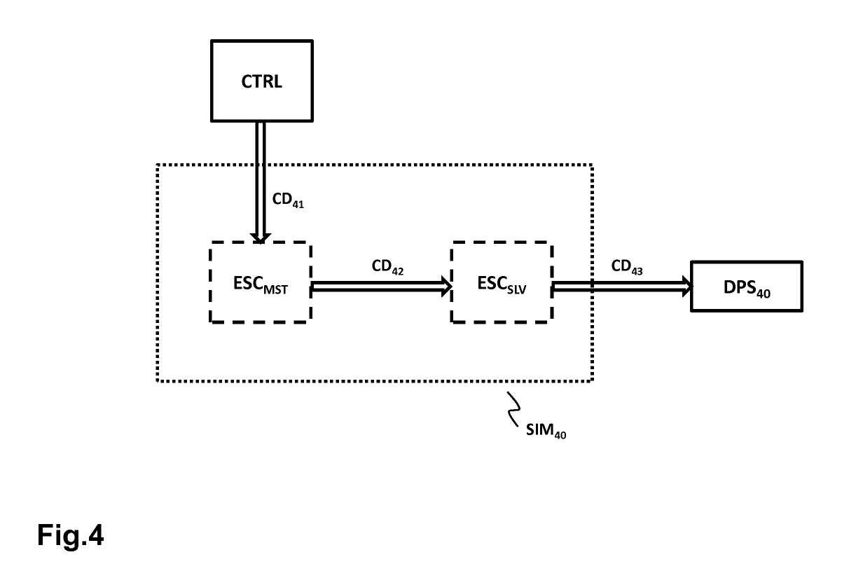

FIG. 4 is a block diagram schematically illustrating an exemplary simulation system in a “master and slave” architecture, according to an embodiment. In the shown simulation system SIM₄₀, two encapsulating simulation components ESC_{MST}, ESC_{SLV} are in a “master and slave” relationship and they are jointly managed by an external module CTRL which is a controller module. The master encapsulating simulation component ESC_{MST} acts as input data source and the slave encapsulating simulation component ESC_{SLV} is advantageously enabled to start a simulation “on-demand”, i.e. upon receiving the according input from its master encapsulating simulation component ESC_{MST}. The output result data of the slave encapsulating simulation component ESC_{SLV} is sent to an external module DPS₄₀ in form of a data processing system for data result processing. All the four shown blocks communicate with each other with communication data in a standardized format CD₄₁, CD₄₂, CD₄₃. Such embodiment proves particularly convenient for performing “off-line” or “hybrid” simulations of as for example often needed in car-parking systems. In this case, it is possible to asynchronously run only one or few partial simulation chunks, e.g. parking units, to get data about parking times and possibilities in the current situation.

Embodiments, at least one simulation component SCᵢ may comprise one or more real or virtual sample cells, data source components or others simulation engines if they are compatible with each other. Some examples of sample cell types are mentioned and illustrated below.

FIG. 5 shows a block diagram schematically illustrating an example embodiment of an encapsulating simulation component ESC_{RCEL} wherein the corresponding simulation component SC_{RCEL} is an active real sample cell. A real sample cell simulates the behavior of a real item in a sample environment, which can be for example “ad-hoc” designed for testing purposes. Such real sample cell is particularly convenient to simulate industrial process types which are difficult to be modeled mathematically. For example, assume that it is required to simulate the behavior of the electrical resistance of a given metallic wire in a specific aggressive environment. In such case, a corrosion sample cell can be designed. In FIG. 5 it is shown an example embodiment of a simulation component SC_{RCEL} which is a real sample cell, for example a corrosion sample cell, comprising an impact generator IG, a real sample item RSI and a measuring device MD. The real sample item RSI is the given metallic wire positioned in a tank with a chosen aggressive solution. The measuring device MD measures the electrical resistance of the given metallic wire in dependence of some changing conditions, in order to provide a controlled imitation of some environmental conditions, modifiable by the impact generator IG, which may for example be the temperature or the composition of the solution. For the simulation component SC_{RCEL}, it is defined an encapsulating simulation component ESC_{RCEL} so that the transformation between data in a proprietary format ID₅₀, OD₅₀, and data in a standardized format ICD₅₀, OCD₅₀ is performed, advantageously enabling to exchange information with other encapsulating simulation components or external modules in a standardized format. The real sample cell SC_{RCEL} shown in FIG. 5 is called “active” in that the impact generator IG is actively modifying the testing conditions through inputs received from an external module (not shown). In other embodiments, a real sample cell can be a “passive” real sample cell (not shown) such cell would be without active input, such passive real sample cell may for example be a sensor or a probe. A passive real sample cell example would then comprise only the real sample item RSI and the measuring device MD. Embodiments, the measuring device MD may be a network of sensors each one with its own identification, for example a network of RF sensors for measuring ecological parameters in a wide industrial area. A real example scenario where the usage of an encapsulating simulation component ESC_{RCEL} of a real sample cell SC_{RCEL} proves to be very useful is in a vitrification plant for nuclear wastes. In fact, in vitrification plants the base industrial process requires the usage of very aggressive melts, so that the tubing is the critical point. By using a real sample cell SC_{RCEL}, it is possible to investigate “into the tube” processes, so that, advantageously, potential severe problems can be foreseen. Moreover, through the encapsulating simulation component ESC_{RCEL} it is provided the possibility to communicate with standardized formatted data OCD₅₀, ICD₅₀ to external modules (not shown). For example, due to safety requirements of the personnel working with tubes with radioactive materials, a connection to an external module being an ALARA system is ideal so that the optimal working paths and scheduling for personnel can be implemented.

FIG. 6 shows a block diagram schematically illustrating an example embodiment of an encapsulating simulation component ESC_{VCEL} wherein the corresponding simulation component is a virtual sample cell SC_{VCEL}. A virtual sample cell is simulating the behavior of a real sample cell, for example via a mathematical model or via a parameter data structure. The example embodiment of the virtual sample cell SC_{VCEL} shown in FIG. 6 comprises a microprocessor μP, a software program SWP, and a memory MEM. A parameter data structure may be consisting of data received from a real sample cell, in such a case the virtual sample cell acts a mediator interacting with a real sample cell, or may be consisting of static recorded results, e.g. a multidimensional matrix with real item parameters in dependence of impact factors prerecorded in previously performed test of real sample cells. The information contained in the parameters data structure can be retrieved in accordance with the required external impacts. The encapsulating simulation component ESC_{VCEL} corresponding to the virtual sample cell component SC_{VCEL}, by transforming data between proprietary format data OD₆₀, ID₆₀ and standardized format data OCD₆₀, ICD₆₀, allows standard communication exchange with other components or modules (not shown). In one embodiment, the other component may be a real sample cell component in order to include the received data within a simulation system. In such embodiment, the encapsulating simulation component ESC_{VCEL} can be used as mediator, through a global network interface, to interact with a real cell component, eventually remotely located. The information received from a real sample cell component (not shown) may be advantageously entered into a library (not shown) so that it can be loaded by other virtual sample cell component or other types of simulation components to be used in any required simulation system.

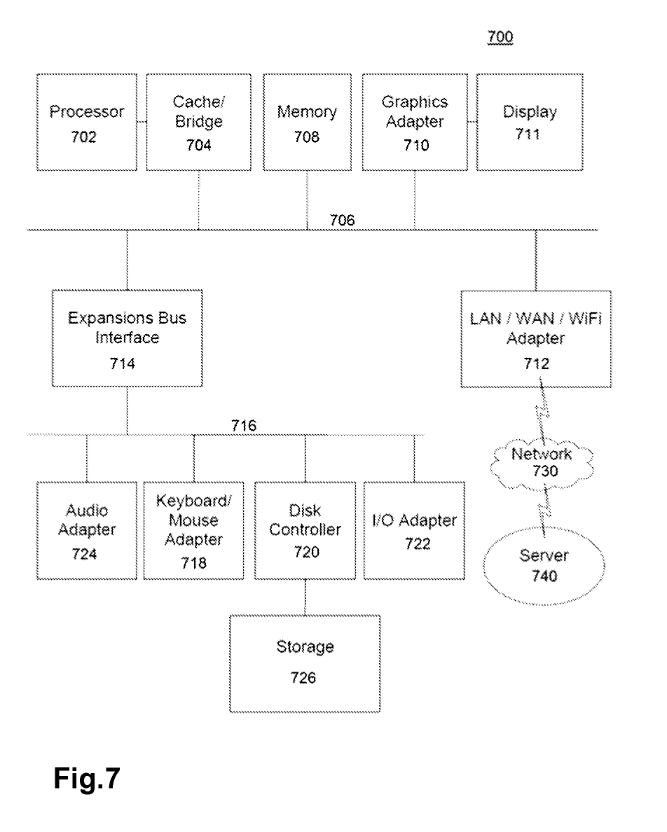

FIG. 7 illustrates a block diagram of a data processing system 700 in which an embodiment can be implemented, for example as a simulation system particularly configured by software or otherwise to perform the processes as described herein, and in particular as each one of a plurality of interconnected and communicating systems as described herein. The data processing system 700 depicted includes a processor 702 connected to a level two cache/bridge 704, which is connected in turn to a local system bus 706. Local system bus 706 may be, for example, a peripheral component interconnect (PCI) architecture bus. Also connected to local system bus in the depicted example are a main memory 708 and a graphics adapter 710. The graphics adapter 710 may be connected to display 711.

Other peripherals, such as local area network (LAN)/Wide Area Network/Wireless (e.g. WiFi) adapter 712, may also be connected to local system bus 706. Expansion bus interface 714 connects local system bus 706 to input/output (I/O) bus 716. I/O bus 716 is connected to keyboard/mouse adapter 718, disk controller 720, and I/O adapter 722. Disk controller 720 can be connected to a storage 726, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 716 in the example shown is audio adapter 724, to which speakers (not shown) may be connected for playing sounds. Keyboard/mouse adapter 718 provides a connection for a pointing device (not shown), such as a mouse, trackball, trackpointer, touchscreen, etc.

Those of ordinary skill in the art will appreciate that the hardware depicted in FIG. 7 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 712 can be connected to a network 730 (not a part of data processing system 700), which can be any public or private data processing system network or combination of networks, as known to those of skill in the art, including the Internet. Data processing system 700 can communicate over network 730 with server system 740, which is also not part of data processing system 700, but can be implemented, for example, as a separate data processing system 700.

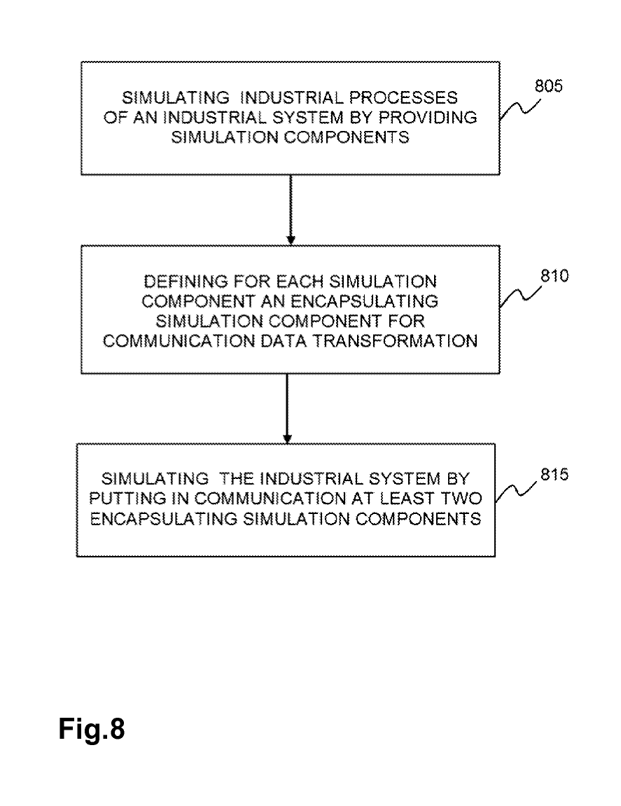

FIG. 8 illustrates a flowchart of a method for simulating an industrial system comprising a plurality of communicating industrial processes in accordance with disclosed embodiments.

In step 805, the system simulates the plurality of industrial processes by providing a set of simulation components wherein each simulation component simulates one or more industrial processes.

In step 810, the system defines, for each simulation component, a corresponding encapsulating simulation component, wherein the encapsulating simulation component is transforming the output data, received by its corresponding simulation component in a proprietary format, into output communication data in a standardized format, in order to send the output communication data to any other encapsulating simulation component and/or to an external module; and, if the encapsulating simulation component receives input communication data in a standardized format from any other encapsulating component and/or from an external module, the encapsulating simulation component is transforming it into input data in a proprietary format specific to its corresponding simulation component, in order to receive the input communication data from any other encapsulating simulation component and/or from an external module.

In step 815, the system simulates the industrial system, by putting in communication at least two encapsulating simulation components with each other which communicate via communication data in a standardized format, so as to mirror the communication of the industrial processes simulated by the corresponding simulation components.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

What is claimed is:

1. A method for simulating an industrial system, wherein said industrial system comprises a plurality of industrial processes in communication with each other directly or indirectly, the method executed by a data processing system comprising the following steps:
a) simulating said plurality of industrial processes by providing a set of simulation components, wherein each simulation component simulates one or more industrial processes;
b) defining, for each simulation component, a corresponding encapsulating simulation component,
wherein said encapsulating simulation component is transforming the output data, received by its corresponding simulation component in a proprietary format, into output communication data in a standardized format, in order to send the output communication data to any other encapsulating simulation component and/or to an external module; and,
if said encapsulating simulation component receives input communication data in a standardized format from any other encapsulating component and/or from an external module, said encapsulating simulation component is transforming it into input data in a proprietary format specific to its corresponding simulation component, in order to receive the input communication data from any other encapsulating simulation component and/or from an external module;
c) simulating said industrial system, by putting in communication at least two encapsulating simulation components with each other which communicate via communication data in a standardized format, so as to mirror the communication of the industrial processes simulated by the corresponding simulation components.

2. The method of claim 1, wherein said simulation component is selected from the group consisting of:
simulation engine;
data source unit;
real sample cell;
virtual sample cell;
any combination of one or more of the above components, if they are compatible.

3. The method of claim 1, wherein at least one simulation component comprises a stochastic based simulation engine.

4. The method of claim 1, wherein said external module is selected from the group consisting of:
user interface module;
data module;
library;
controller;
software application;
data processing system.

5. The method of claim 1, wherein at least one simulation component is connected to a local buffer for storing state data.

6. A data processing system for simulating an industrial system, wherein said industrial system comprises a plurality of industrial processes in communication with each other directly or indirectly, said data processing system comprising:
a processor; and
an accessible memory, said data processing system particularly configured to:
a) simulating said plurality of industrial processes by providing a set of simulation components, wherein each simulation component simulates one or more industrial processes;
b) defining, for each simulation component, a corresponding encapsulating simulation component,
wherein said encapsulating simulation component is transforming the output data, received by its corresponding simulation component in a proprietary format, into output communication data in a standardized format, in order to send the output communication data to any other encapsulating simulation component and/or to an external module; and,
if said encapsulating simulation component receives input communication data in a standardized format from any other encapsulating component and/or from an external module, said encapsulating simulation component is transforming it into input data in a proprietary format specific to its corresponding simulation component, in order to receive the input communication data from any other encapsulating simulation component and/or from an external module;
c) simulating said industrial system, by putting in communication at least two encapsulating simulation components with each other which communicate via communication data in a standardized format, so as to mirror the communication of the industrial processes simulated by the corresponding simulation components.

7. The data processing system of claim 6, wherein said simulation component is selected from the group consisting of:
simulation engine;
data source unit;
real sample cell;
virtual sample cell;
any combination of one or more of the above components, if they are compatible.

8. The data processing system of claim 6, wherein at least one simulation component comprises a stochastic based simulation engine.

9. The data processing system of claim 6, wherein said external module is selected from the group consisting of:
user interface module;
data module;
library;
controller;
software application;
data processing system.

10. The data processing system of claim 6, wherein at least one simulation component is connected to a local buffer for storing state data.

11. A non-transitory computer-readable medium encoded with executable instructions that, when executed, cause one or more data processing systems to simulate an industrial system, wherein said industrial system comprises a plurality of industrial processes in communication with each other directly or indirectly, by:
a) simulating said plurality of industrial processes by providing a set of simulation components, wherein each simulation component simulates one or more industrial processes;
b) defining, for each simulation component, a corresponding encapsulating simulation component,
wherein said encapsulating simulation component is transforming the output data, received by its corresponding simulation component in a proprietary format, into output communication data in a standardized format, in order to send the output communication data to any other encapsulating simulation component and/or to an external module; and,
if said encapsulating simulation component receives input communication data in a standardized format from any other encapsulating component and/or from an external module, said encapsulating simulation component is transforming it into input data in a proprietary format specific to its corresponding simulation component, in order to receive the input communication data from any other encapsulating simulation component and/or from an external module;
c) simulating said industrial system, by putting in communication at least two encapsulating simulation components with each other which communicate via communication data in a standardized format, so as to mirror the communication of the industrial processes simulated by the corresponding simulation components.

12. The non-transitory computer-readable medium of claim 11, wherein said simulation component is selected from the group consisting of:
simulation engine;
data source unit;
real sample cell;
virtual sample cell;
any combination of one or more of the above components, if they are compatible.

13. The non-transitory computer-readable medium of claim 11, wherein at least one simulation component comprises a stochastic based simulation engine.

14. The non-transitory computer-readable medium of claim 11, wherein said external module is selected from the group consisting of:
user interface module;
data module;
library;
controller;
software application;
data processing system.

15. The non-transitory computer-readable medium of claim 11, wherein at least one simulation component is connected to a local buffer for storing state data.
